(19) United States
(12) Patent Application Publication
(10) Pub. No.: US 2007/0182248 A1
(43) Pub. Date: Aug. 9, 2007

(54) Power Supply Circuit for Selectively Supplying Power to a Vehicle Accessory

(76) Inventors: David A. Blaker, Holland, MI (US); Robert R. Turnbull, Holland, MI (US); Eric J. Walstra, Grand Rapids, MI (US); Frederick T. Bauer, Holland, MI (US)

Correspondence Address: PRICE, HENEVELD, COOPER, DEWITT, & LITTON,;LLP/GENTEX CORPORATION, 695 KENMOOR, S.E., P O BOX 2567, GRAND RAPIDS, MI, 49501, US

(21) Appl. No.: 11/670,622

(22) Filed: Feb. 2, 2007

Related U.S. Application Data
(60) Provisional application No. 60/764,495, filed on Feb. 2, 2006.

(51) Int. Cl. B60L 1/00

(52) U.S. Cl. 307/10.1

(57) ABSTRACT

According to one embodiment of the present invention, a power supply circuit is provided for selectively supplying power to a vehicle accessory. The power supply circuit may be comprised of a switch coupled to a power line from the vehicle battery and to a power input of the accessory, and a control circuit coupled to the switch. The control circuit may monitor the battery voltage and selectively supply power from the battery to the accessory in response to the battery voltage. The control circuit may supply power from the battery to the accessory when the battery voltage changes at least a predetermined amount over a time period. The control circuit may comprise a microprocessor that adaptively learns signatures in the battery voltage occurring when the engine is running in order to provide power from the battery to the accessory as if the power were supplied from the ignition.

### CROSS-REFERENCE TO RELATED APPLICATION

This application claims the benefit of U.S. Provisional Application No. 60/764,495, filed on Feb. 2, 2006, the entire disclosure of which is incorporated herein by reference.

### BACKGROUND OF THE INVENTION

In general, the present invention pertains to a power supply circuit for selectively supplying power to a vehicle accessory. More particularly, the power supply circuit is configured to receive power from the vehicle battery while selectively providing power to one or more vehicle accessories as if those vehicle accessories were otherwise powered from the vehicle ignition (i.e., the vehicle accessories are not supplied with power when the vehicle is not running).

Vehicles are now sold with a wide variety of electrical accessories. These vehicle accessories may be installed at the vehicle factory, at an auto dealership, or may be installed by the purchaser as an aftermarket product.

Different vehicle accessories require power at different times. In general, vehicle accessories are typically supplied with power via the vehicle ignition line, which only provides power so long as the key is turned in the ignition or when the vehicle engine is running. Nevertheless, some vehicle accessories may be powered via a vehicle battery line whereby power is provided from the vehicle battery at all times regardless of whether the vehicle is running. However, vehicle manufacturers generally do not run an ignition line to every possible location in a vehicle where a vehicle accessory may be placed. Moreover, wiring is quite expensive and wires cannot always be run through certain locations in the vehicle due to the presence of airbags and the like. One location where an ignition line is sometimes not provided is the vehicle headliner. Instead, the auto manufacturers may only provide a battery line to the vehicle headliner for operation of a dome light and or other reading or lamp lights. Thus, if one wishes to place a vehicle accessory in the vehicle headliner, they would need to draw power from the vehicle battery line. A consequence of connecting the vehicle accessory to the battery line is that the vehicle accessory may remain on, even when the vehicle is not running, and thus unnecessarily drain the vehicle battery.

To address this problem, power supply circuits have been proposed that connect between the battery line and the vehicle accessory to detect the presence of electrical noise on the battery line that results from the charging of the battery by the alternator when the vehicle is running. Thus, in theory, these power supply circuits only supply power to the vehicle accessory when the vehicle's engine is running. Examples of such power supply circuits are disclosed in U.S. Pat. Nos. 4,733,100, 5,073,721, and 5,903,063. As pointed out in U.S. Pat. No. 5,073,721, however, a problem arises insofar as various vehicle accessories may also produce noise on the battery line regardless of whether the vehicle is running. This is particularly problematic if the vehicle accessory that is being provided power by the power supply circuit generates noise itself that is fed back over the battery line when the vehicle accessory is operated. Thus, the power supply circuit would provide power to the vehicle accessory when the noise from the alternator is detected and would continue to provide power to the vehicle accessory so long as noise is detected on the battery line even though this noise may no longer be generated by the alternator but rather only by the vehicle accessory itself. Thus, these systems are prone to false detections which may result in undesirable draining of the vehicle battery.

### SUMMARY OF THE INVENTION

According to one embodiment of the present invention, a power supply circuit is provided for selectively supplying power to an accessory in a vehicle. The power supply circuit comprises: a switch coupled to a power line from a battery of the vehicle and to a power input of the accessory; and a control circuit coupled to the switch, the control circuit comprising a microprocessor for monitoring a voltage level of the battery and for selectively activating the switch to supply power from the battery to the accessory in response to a sequence or combination of events.

According to another embodiment of the present invention, a power supply circuit is provided for selectively supplying power to an accessory in a vehicle. The power supply circuit comprises: a switch coupled to a power line from a battery of the vehicle and to a power input of the accessory; and a control circuit coupled to the switch, the control circuit monitors a voltage level of the battery and selectively supplies power from the battery to the accessory in response to the voltage level of the battery, wherein the control circuit supplies power from the battery to the accessory when the voltage level of the battery increases at least a predetermined amount.

According to another embodiment of the present invention, a power supply circuit is provided for selectively supplying power to an accessory in a vehicle. The power supply circuit comprises: a switch coupled to a power line from a battery of the vehicle and to a power input of the accessory; and a control circuit coupled to the switch, the control circuit monitors a voltage level of the battery and selectively supplies power from the battery to the accessory in response to the voltage level of the battery, wherein the control circuit supplies power from the battery to the accessory when the voltage level of the battery decreases from a nominal voltage level by a first predetermined amount to a lower voltage level and subsequently increases a second predetermined amount to a higher voltage within a predetermined time period.

According to another embodiment of the present invention, a power supply circuit is provided for selectively supplying power to an accessory in a vehicle. The power supply circuit comprises: a switch coupled to a power line from a battery of the vehicle and to a power input of the accessory; and a control circuit coupled to the switch, the control circuit monitors a voltage level of the battery, computes an average of the battery voltage level, and selectively supplies power from the battery to the accessory in response to the averaged voltage level of the battery.

According to another embodiment of the present invention, a power supply circuit is provided for selectively supplying power to an accessory in a vehicle. The power supply circuit comprises: a switch coupled to a power line from a battery of the vehicle and to a power input of the accessory; and a control circuit coupled to the switch, the control circuit monitors a voltage level of the battery and selectively supplies power from the battery to the accessory in response to the voltage level of the battery, wherein the control circuit disrupts a supply of power from the battery to the accessory when the voltage level of the battery decreases from a first voltage level by at least a predetermined amount to a lower voltage level.

According to another embodiment of the present invention, a power supply circuit is provided for selectively supplying power to an accessory in a vehicle. The power supply circuit comprises: a switch coupled to a power line from a battery of the vehicle and to a power input of the accessory; and a control circuit coupled to the switch, the control circuit monitors a voltage level of the battery and selectively supplies and disrupts power from the battery to the accessory in response to at least two of the following inputs in addition to a time duration of detected events: a voltage level of the battery; a vibration sensor output signal; a light level within the vehicle; noise on the power line from the battery; a door open signal; a timer signal; a signal read from the vehicle accessory; and a dome light on signal.

According to another embodiment of the present invention, an accessory for mounting in a vehicle is provided. The accessory for mounting in a vehicle comprises: a power source; an electrical component; a switch coupled between said electrical component and said power source; and a control circuit coupled to said switch and selectively supplies and disrupts power from said power source to said electrical component in response to at least one of the following inputs: a motion sensor output signal; a vibration sensor output signal; a light level within the vehicle; and a dome light ON signal.

These and other features, advantages, and objects of the present invention will be further understood and appreciated by those skilled in the art by reference to the following specification, claims, and appended drawings.

### BRIEF DESCRIPTION OF THE DRAWINGS

In the drawings:

FIG. 1 is an electrical circuit diagram in block form of an example of a power supply circuit constructed in accordance with the present invention;

FIG. 2 is perspective view of a vehicle accessory and an exemplary power supply circuit constructed in accordance with the present invention;

FIG. 3 is an electrical circuit diagram in schematic form illustrating an example of a power switch that may be used in the power supply circuit of the present invention;

FIG. 4 is an electrical circuit diagram in schematic form illustrating an example of a battery voltage divider circuit that may be used in the power supply circuit of the present invention;

FIG. 5 is an electrical circuit diagram in schematic form illustrating an example of a power supply that may be used in the power supply circuit of the present invention;

FIG. 6 is an electrical circuit diagram in schematic form illustrating an example of a dome light status detection circuit that may be used in a power supply circuit of the present invention;

FIG. 7 is an electrical circuit diagram in schematic form illustrating an example of a vibration sensing circuit that may be used in a power supply circuit of the present invention;

FIG. 8 is an electrical circuit diagram in schematic form illustrating an example of a noise amplifying circuit that may be used in the power supply circuit of the present invention;

FIG. 9 is a timing diagram illustrating an example of a battery voltage reading during starting and stopping of the vehicle engine and a corresponding power on/off signal generated by a power supply circuit constructed in accordance with the present invention; and

FIGS. 10A -10C are flow charts illustrating an example of a routine that may be executed by a microprocessor within a power supply circuit constructed in accordance with the present invention.

### DETAILED DESCRIPTION OF THE PREFERRED EMBODIMENTS

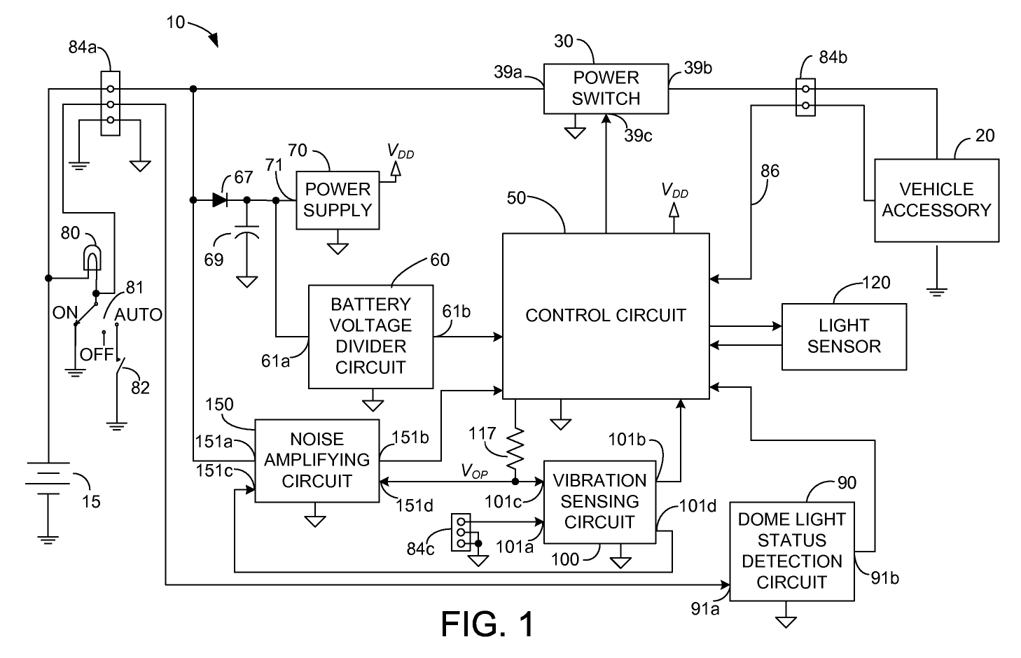

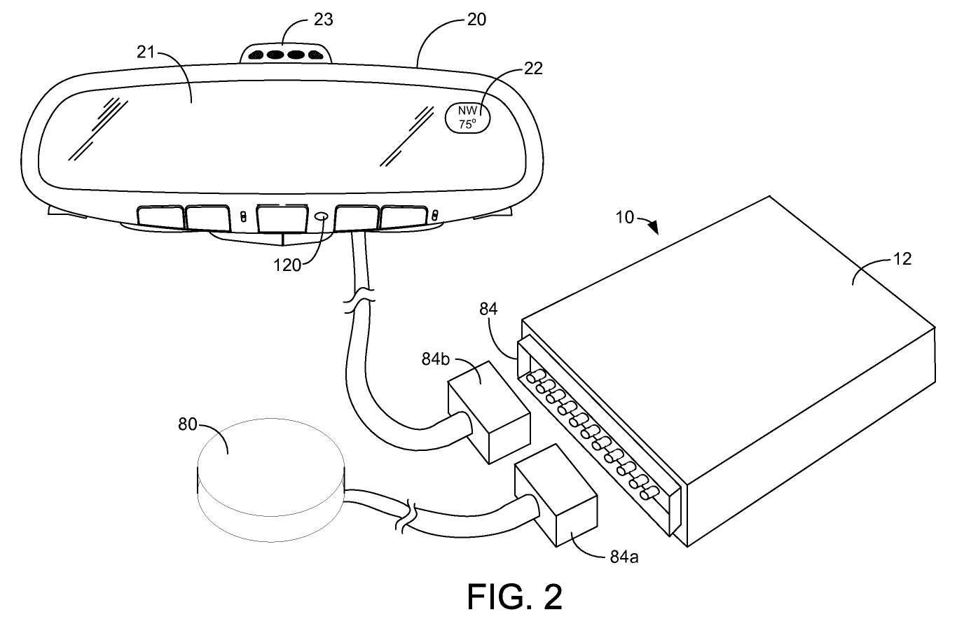

An example of a power supply circuit 10 constructed in accordance with the present invention is shown in FIG. 1. As illustrated, power supply circuit 10 is connected between a vehicle battery 15 and a vehicle accessory 20. More particularly, a power switch 30 is coupled between battery 15 and vehicle accessory 20 and is controlled to selectively connect or disconnect the battery 15 from vehicle accessory 20 in response to a control signal supplied by a control circuit 50, which may comprise a microprocessor. It should be appreciated that power supply circuit 10 may be implemented anywhere within the vehicle and may be included in its own housing 12 as shown in FIG. 2 or it may be incorporated within a housing of a vehicle accessory 20 or some other component of the vehicle accessory such as a connection block or even a cigarette lighter which would plug into a battery-operated cigarette lighter opening.

As stated above, power supply circuit 10 is preferably configured to receive power from the vehicle battery 15 and to provide power to the vehicle accessory in such a manner as to mimic the power signal that would otherwise be applied to the vehicle accessory if it were connected to the vehicle ignition line. In the examples that follow, vehicle accessory 20 is described as a rearview mirror assembly, and power supply circuit 10 is described as being connected to a battery line that is run to a light 80 which may be the dome light, map or reading lights of the vehicle. It will be appreciated, however, that power supply circuit 10 may be used to power any type of vehicle accessory including accessories mounted in overhead consoles, pillar consoles, floor consoles, on-windshield consoles, the instrument panel, lighting modules provided in a headliner or any other location within the vehicle.

In the example in which vehicle accessory 20 is a rearview mirror assembly (as shown in FIG. 2), the rearview mirror assembly may include a variety of electrical components that may receive power from power supply circuit 10. For example, rearview mirror assembly 20 may include an electrochromic mirror element 21, an electronic compass and other display 22, a hands-free microphone 23, as well as various other accessories that are known to be mounted in rearview mirror assembly. An example of a rearview mirror assembly that utilizes these components that would be a candidate for connecting to the power supply circuit 10 is that which is disclosed in U.S. Patent Application Publication No. US 2004/0246607 A1, the entire disclosure of which is incorporated herein by reference.

The example of power supply circuit 10 shown in FIG. 1 further depicts the inclusion of a battery voltage divider circuit 60, a power supply 70, a dome light status detection circuit 90, a vibration sensing circuit 100, a light sensor 120, and a noise amplifying circuit 150. As will be apparent from the discussion below, battery voltage divider circuit 60, dome light status detection circuit 90, vibration sensing circuit 100, light sensor 120, and noise amplifying circuit 150 are all optional components so long as at least one of these circuits is provided to predict or identify conditions related to the starting, operation, and turning off of the vehicle. It will also be apparent from the discussion below that at least two of these circuits or even all of these circuits may be employed to provide inputs that control circuit 50 may utilize to make a more robust determination as to whether or not the engine is running and thus reduce the possibility of any false detections while relying on only a single one of these inputs. The details of each of circuits 60, 90, 100, 120, and 150, as well as the details of power supply 70 and power switch 30. are discussed further below.

As discussed above, control circuit 50 may comprise or consist entirely of a microprocessor. Examples of two suitable microprocessors are Microchip 16F684 (14 pin) and 12F675 (8 pin).

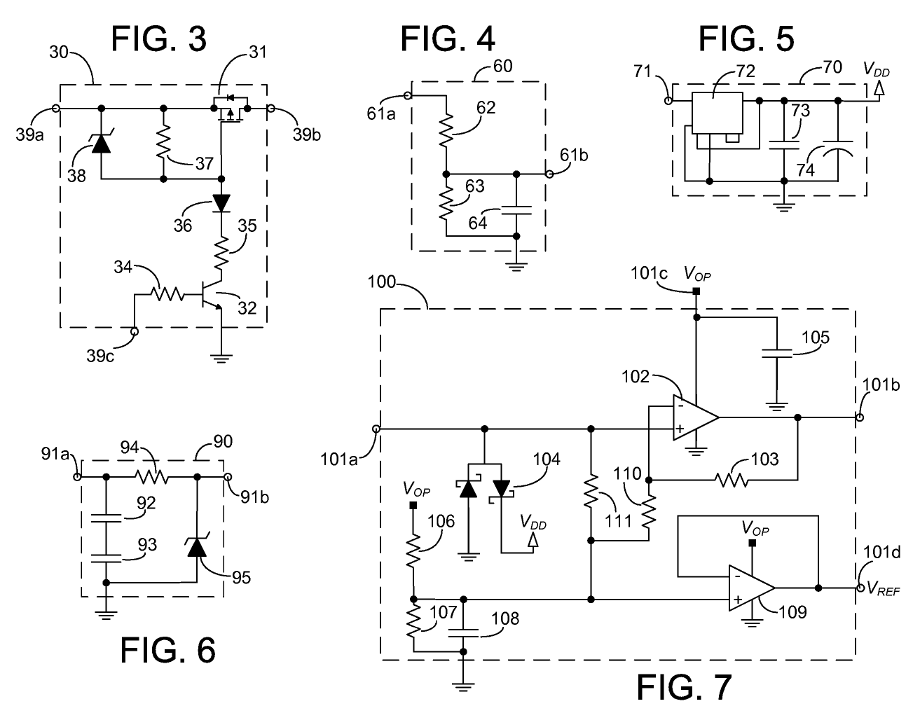

FIG. 3 shows one example of how power switch 30 may be constructed. As illustrated, switch 30 may include a power MOSFET 31 coupled to selectively connect or disrupt the flow of current from terminal 39a to terminal 39b, which may be connected respectively to the battery voltage line and the power input terminal of vehicle accessory 20. A transistor 32 may be provided to selectively connect the gate of MOSFET 31 to ground in response to a control signal applied to terminal 39c by control circuit 50. A resistor 34, which may have a resistance of, for example, 1 kΩ, may be connected between terminal 39c and the base of transistor 32. The emitter of transistor 32 may be connected to ground while the collector may be coupled to the gate MOSFET 31 via a resistor 35 and a diode 36. Resistor 35 may have a resistance of, for example, 10 kΩ. Diode 36 may be provided for reverse battery connection protection. A resistor 37 and a Zener diode 38 may be connected in parallel between the gate of MOSFET 31 and terminal 39a. Resistor 37 may have a resistance of, for example, 10 kΩ.

FIG. 4 shows an example of a voltage divider circuit 60 that may be used in the power supply circuit 10 of the present invention. According to a first embodiment of the present invention, power supply circuit 10 may monitor the voltage level of battery 15 to look for characteristics that would suggest that the engine has been started or turned off. In this event, it may be desirable to include battery voltage divider circuit 60 to adjust the level of the battery voltage applied to the terminal of control circuit 50 which may be a microprocessor. As shown in FIG. 1, the voltage from battery 15 may be applied via a connector 84a to terminal 61a of voltage divider circuit 60 by way of a diode 67 and a capacitor 69 which may be coupled between the cathode of diode 67 and ground. Capacitor 69 may have a capacitance of 22 μF.

Voltage divider circuit 60 may include two resistors 62 and 63 which may have respective resistances of 200 kΩand 10 kΩ. The resistances of these resistors may be selected to ensure that the voltage that is output from terminal 61b and thus applied to a terminal of the microprocessor of control circuit 50 is within the voltage range that is detectable by the control circuit. Control circuit 50 may preferably include a microprocessor that may include an analog-to-digital converter such that the analog voltage output from terminal 61b may be applied directly to an input terminal of the microprocessor. Voltage divider 60 may further include a capacitor 64 which may have, for example, a capacitance of 0.01 μF.

FIG. 5 shows an example of a power supply 70 that may be employed in the power supply circuit 10 of the present invention. Power supply 70 may receive the same voltage level from battery 15 that is applied to the battery voltage divider circuit 60. This voltage may be applied to terminal 71 of power supply 70 and may be input to a voltage converter 72 which may, for example, be an LM 2951-5 integrated circuit. Voltage converter 72 may convert the voltage supplied from battery 15 to a voltage V_{DD}, which may be used internally within the power supply circuit 10 to power various components including the microprocessor of control circuit 50. Power supply 70 may further include a first capacitor 73, which may have a capacitance of 0.1 μF, and a second capacitor 74 which may have a capacitance of 22 μF. Capacitors 73 and 74 may thus serve to regulate the otherwise unregulated voltage provided from vehicle battery 15.

FIG. 6 shows an example of a dome light status detection circuit 90 that may be used in the power supply circuit 10 of the present invention. As shown in FIG. 1, the battery voltage 15 may be obtained from a dome light 80 (or any other electrical component that otherwise receives the battery voltage in the vicinity where the vehicle accessory 20 will be mounted). Many dome lights now employ a switch 81 next to the light such that a vehicle occupant may manually turn the light on or off for reading or other purposes. This switch 81 may be a simple two-position on/off switch or it may be a three-way switch with a third position corresponding to automatic on/off whereby the dome light 80 is automatically turned on and off by the vehicle through a switch 82, which may be a door switch, a switch that is responsive to a remote keyless entry (RKE) signal, or the like. An indication as to whether or not a dome light 80 or other interior light has been turned on by the opening of a door may be valuable information to provide to control circuit 50 in determining whether or not to activate the vehicle accessory as a whole or at least a component within the vehicle accessory. Accordingly, the power supply circuit 10 may be provided with a signal from the dome light or other light that would then be input to an input 91a of dome light status detection circuit 90. Dome light status detection circuit 90 essentially conditions the received signal for input to the microprocessor of control circuit 50. Referring back to FIG. 6, dome light status detection circuit 90 may include first and second capacitors 92 and 93 coupled between the first terminal 91a and ground. Capacitor 92 may have a capacitance of, for example, 0.01 μF. Capacitor 93 may also have a capacitance of 0.01 μF. A resistor 94 may be connected between terminals 91a and 91b. Resistor 94 may have a resistance of 100 kΩ, for example. A Zener diode 95 may be connected between output terminal 91b and ground.

As discussed above, a vibration sensing circuit 100 may be provided within power supply circuit 10. Vibration sensing circuit 100 may be connected to a vibration sensor that is provided internally within housing 12 of power supply circuit 10 or which may be connected externally thereto via a connector terminal 84c. Suitable vibration sensors include a moving magnet type, a motion switch, an accelerometer or a peizo film, such as the LDT Series Piezo Film Sensor available from Measurement Specialties. The output of the vibration sensor may be provided to terminal 101a of vibration sensing circuit 100. An example of a vibration sensing circuit 100 that may be used is shown in FIG. 7. The vibration sensing circuit shown in FIG. 7 may provide two separate functions. First, it may amplify the signal received from the vibration sensor for providing the signal directly to the microprocessor of control circuit 50 via terminal 101b, while it may also generate a reference voltage V_{REF} that is output from terminal 101d and provided to terminal 151c of noise amplifying circuit 150 (if provided). Again, if noise amplifying circuit 150 is not provided, certain parts of the circuit shown in FIG. 7 may be eliminated. The vibration sensing circuit 100 may be used to sense the motion of the vehicle and hence function as a motion sensor. The motion of the vehicle may also be sensed utilizing compass sensors (if already provided in the vehicle) to sense whether the vehicle direction is changing, utilizing accelerometers, or by simply looking for a certain vibration characteristic. The motion of the vehicle may be taken into account by control circuit 50 in determining whether to supply power to an accessory.

As shown in FIG. 7, vibration sensing circuit 100 includes an operational amplifier 102 which has its positive terminal connected to input terminal 101a. A pair of blocking diodes 104 may be provided to protect and limit the voltage applied at terminal 101a prior to application to operational amplifier 102. The signal appearing at the output of operational amplifier 102 may be fed back to the negative terminal of operational amplifier 102 after being divided by a voltage divider including resistors 103 and 110. Resistor 103 may have a resistance of, for example, 1 kΩ while resistor 110 may have a resistance of 47 kΩ. Operational amplifier 102 may receive an operating voltage V_{OP} at terminal 101c which is provided by control circuit 50 via a resistor 117, which may have a resistance of, for example, 100 Ω. A capacitor 105 may be coupled between ground and the input terminal 101c where V_{OP} is supplied. Capacitor 105 may have a capacitance of, for example, 0.01 μF. By providing the operating voltage from the microprocessor of control circuit 50, the operational amplifiers may be periodically powered down so as not to draw too much power and thereby drain the vehicle battery when the vehicle is not in use.

If a noise amplifying circuit 150 is provided in power supply circuit 10, vibration sensing circuit 100 may include a voltage reference generator which generally includes an operational amplifier 109 having its positive terminal connected to input terminal 101a via a resistor 111, which may have a resistance of, for example, 1 kΩ, and to a voltage divider circuit including resistors 106 and 107 and a capacitor 108 that may be coupled between the voltage V_{OP} and ground. Resistors 106 and 107 may have a resistance of, for example, 10 kΩ, while capacitor 108 may have a capacitance of 0.01 μF. The negative terminal of operational amplifier 109 may be coupled to the received feedback of the output signal of amplifier 109. Operational amplifiers 102 and 109 may be implemented using model numbers TLC2721D.

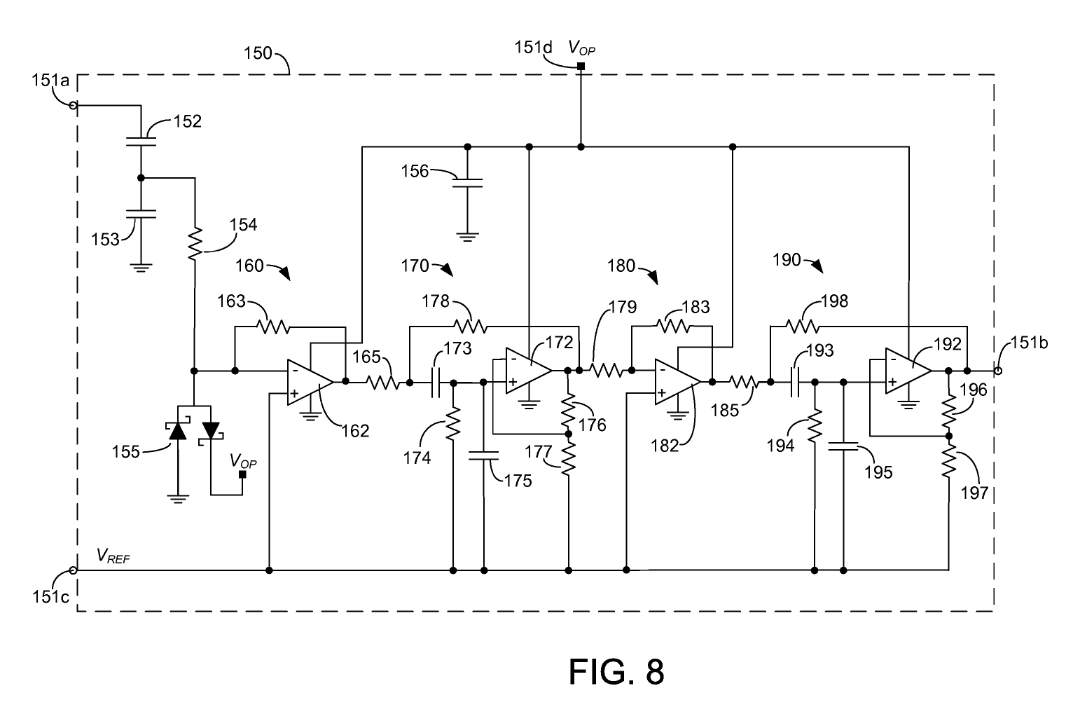

As noted above, power supply circuit 10 may optionally include noise amplifying circuit 150. Because the battery voltage level may be applied directly to the microprocessor of control circuit 50 via battery voltage divider circuit 60, the noise fluctuations of the voltage that are caused by the alternator when the engine is running may be too small to be sensed by the A/D converter within the microprocessor. Thus, the noise amplifying circuit 150 may be provided to amplify the noise level imposed on the battery line for sensing by the microprocessor. As illustrated in FIGS. 1 and 8, noise amplifying circuit 150 includes an input terminal 151a to which the battery voltage is directly applied. Noise amplifying circuit 150 provides an output at terminal 151b that is applied directly to the microprocessor of control circuit 50. Noise amplifying circuit 150 may further include an input terminal 151c for receiving the reference voltage V_{REF} from vibration sensing circuit 100. In addition, input terminal 151d may be provided to receive the operating voltage V_{OP} that is provided from control circuit 50 via resistor 117.

As shown in FIG. 8, noise amplifying circuit 150 may include a capacitor 152 having one end connected to input terminal 15a and the other terminal connected to ground via another capacitor 153 and further connected to a resistor 154. Capacitor 152 may have a capacitance of, for example, 0.01 μF while capacitor 153 may also have a capacitance of 0.01 μF. Resistor 154 may have a resistance of 1 kΩ. A diode protection circuit 155 may be provided at the other end of resistor 154 to protect the circuit from over voltages. The input signal after passing through capacitor 152 and resistor 154 is then fed to a first amplifier stage 160, which may, for example, have a 10× gain. The amplified noise signal may then be passed through a first band pass filter stage 170, which preferably has a 2 kHz pass band. The filtered and amplified output may then be applied to a second amplifier stage 180, which also preferably has a 10× gain. The output from second amplifier stage 180 may be passed through a second band pass filter stage 190 or gain stage again having a 2 kHz pass band. The output of second band pass filter stage 190 may thus be applied at output terminal 151b and may be applied to an input terminal of the microprocessor within control circuit 50.

First amplifier stage 160 may include an operational amplifier 162 having a positive voltage connected to input terminal 151c for receiving reference voltage V_{REF}, and having its negative terminal connected to input terminal 151a via capacitor 152 and resistor 154. A feedback loop may be provided between the output of operational amplifier 162 and the negative input via resistor 163, which may have a resistance of, for example, 10 kΩ. The output of operational amplifier 162 may also be passed through a resistor 165, which may have a resistance of, for example, 1 kΩ. The output of this resistor may be applied to first band pass filter stage 170.

First band pass filter stage 170 may include an operational amplifier 172 having its positive terminal connected to resistor 165 via a capacitor 173, which may have a capacitance of, for example, 0.1 μF. First band pass filter stage 170 may further include a resistor 174 and a capacitor 175 coupled in parallel between the positive input to operational amplifier 172 and input 151c to which the V_{REF} is applied. Resistor 174 may have, for example, a resistance of 82 kΩ, while capacitor 175 may have a capacitance of 0.1 μF. A feedback resistor 178, which may have a resistance of, for example, 82 kΩ, may be coupled between the output of operational amplifier 172 and a terminal between resistor 165 and capacitor 173. Two resistors 176 and 177 couple the output of operational amplifier 172 to input terminal 151c. A terminal between resistors 176 and 177 may be connected to the negative input of operational amplifier 172. Resistor 176 may have resistance of, for example, 2.15 kΩ while resistor 177 may have a resistance of 1 kΩ. The output of operational amplifier 172 may be coupled to the negative input of an operational amplifier 182 of the second amplifier stage 180 via a resistor 179. Resistor 179 may have a resistance of, for example, 1 kΩ. The positive input of operational amplifier 182 may be connected to input line 151c to receive the voltage V_{REF}. The output of operational amplifier 182 may be coupled to the negative input terminal of operational amplifier 182 via a feedback resistor 183, which has a resistance of, for example, 10 kΩ.

A resistor 185 and a capacitor 193 may be connected in series between the output of operational amplifier 182 and the positive input terminal of an operational amplifier 192 of the second band pass filter stage 190. Resistor 185 may have a resistance of 1 kΩ while capacitor 193 may have a capacitance of 0.1 μF. A resistor 194 and a capacitor 195 may be connected in parallel between the positive input terminal of operational amplifier 192 and input line 151c. Resistor 194 may have a resistance of 82 kΩ while capacitor 195 may have a capacitance of 0.1 μF. The second filter stage 190 further includes resistors 196 and 197 that may be coupled in series between the output of operational amplifier 192 and input terminal 151c. A terminal between resistors 196 and 197 may be coupled to the negative input terminal of amplifier 192. Resistor 196 may have a capacitance of, for example, 2.15 kΩ while resistor 197 may have a resistance of 1 kΩ. Filter stage 190 may further include a feedback resistor 198 that may be coupled to the output of amplifier 192 and may be coupled to a terminal between resistor 185 and capacitor 193. The output of operational amplifier 192 may be provided to output terminal 151b of noise amplifying circuit 150, which in turn may be supplied to an input terminal of the microprocessor of control circuit 50.

The four operational amplifiers may all be the same model of amplifier such as, for example, an LM2904. The power terminals of each of the four operational amplifiers 162, 172, 182 and 192, may be coupled to input terminal 151d to which the voltage V_{OP} is applied. A capacitor 156 may be coupled between input terminal 151d and ground. Capacitor 156 may have a capacitance of, for example, 0.01 μF.

Having described detailed schematic examples for each of the components shown in the power supply circuit 10 of FIG. 1, a description will now be made of one manner by which power supply circuit 10 may be operated. Again, it is noted that the schematics described above are provided for purposes of example only and the detailed construction of the components shown in FIGS. 1-8 may vary from the detailed examples described.

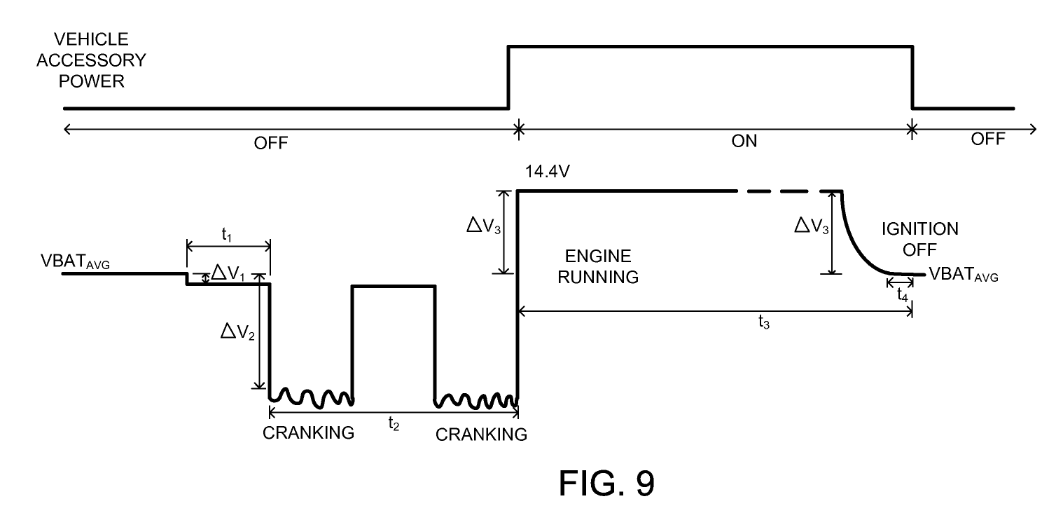

As mentioned above, one preferred construction of power supply circuit 10 includes battery voltage divider circuit 60 used to provide a voltage to the A/D converter input terminal of the microprocessor in control circuit 50. In this manner, the microprocessor may monitor the battery voltage and determine whether the vehicle is running based upon the sensed changes in the battery voltage as described below. In this manner, the microprocessor may also or alternatively monitor the battery voltage and determine whether the vehicle is running based upon the sensed changes in the battery voltage over time as described below. With reference to FIG. 9, the lower plot shown illustrates an example of the relative changes in the battery voltage that occur when a person first enters the vehicle and/or unlocks the vehicle doors, and when the ignition is engaged and the engine is cranked to the point when the engine is running. In particular, when the vehicle is at rest, the battery has a relatively constant nominal voltage. However, this may only be true to some degree insofar as the temperature of the battery may significantly change the voltage. Thus, it is preferred that the control circuit 50 compute an average VBAT_{AVG} over predetermined time intervals such that rather than looking to see if the battery voltage falls to a preset threshold level or rises to a preset threshold level, control circuit 50 instead looks to determine if the change in voltage from the average voltage VBAT_{AVG} exceeds or falls below predetermined voltage change thresholds.

With reference to FIG. 9, the battery voltage illustrated initially is the battery voltage when the vehicle is at rest. Subsequently, the battery voltage may drop an amount greater than ΔV₁ that may occur at the instant in time in which a person either opens a door or unlocks the door(s) with a key or RKE key fob. This initial drop voltage is relatively small but is within the detection limits of the A/D converter of the microprocessor within control circuit 50. This voltage drop usually results from the vehicle bus waking up and operating various devices in response to this signal.

Subsequently, the driver enters the vehicle and engages the ignition which causes the engine to begin cranking. This represents a large load on the vehicle battery thus producing a voltage drop of in excess of ΔV₂. It may take a couple of attempts to start a cold vehicle as illustrated in FIG. 9. If the vehicle is warm, the battery voltage may only drop once and then subsequently rise to a higher level which is at least ΔV₃ greater than the beginning nominal voltage. This represents that the engine has started and that the alternator is now charging the battery causing the battery voltage to rise. The battery voltage level remains at this high level until such time that the vehicle ignition is turned off. It has been recognized that the battery voltage does not drop immediately after the ignition is turned off, but rather may drop gradually over approximately a 10 second interval before reaching the same nominal battery voltage referenced at the beginning of this example.

As shown in the upper of the two graphs shown in FIG. 9, the microprocessor monitors the battery voltage and controls the switch 30 so as to provide power to vehicle accessory 20 at such time that the battery voltage jumps to the higher voltage level associated with the vehicle engine running. While it is conceivable that the control circuit 50 could simply look for an increase in battery voltage of at least ΔV₃ to turn on the power to the vehicle accessory, it may be beneficial to ensure that the increase in battery voltage level is a result of the engine being started rather than some other trigger that could cause the battery voltage to rise, such as a person connecting a battery charger to battery 15. Thus, rather than relying solely on the increase ΔV₃ in the battery voltage, the power supply circuit 10 of the present invention may be configured such that the control circuit 50 looks for the entry or the unlocking of the vehicle and/or the drop in voltage of at least ΔV₂ resulting from the engine cranking.

The entry or unlocking of the vehicle may be detected in a number of ways. First, the control circuit 50 may look for the drop in voltage of at least ΔV₁. Alternatively, the control circuit 50 may receive input from dome light status detection circuit 90 that the dome light has been turned on as a result of door switch 82 being closed thus showing the opening of the vehicle door. Alternatively, or additionally, control circuit 50 may take readings from a light sensor 120 that may be provided on housing 12 of the power supply circuit 10 or provided externally and coupled via a connector. The light sensor may be directed at the dome light or other light within the vehicle where that light would turn on when the doors are unlocked or the door is opened. If the vehicle accessory 20 is a rearview mirror as shown in FIG. 2, and that rearview mirror assembly includes an electrochromic mirror 21, then light sensor 120 may be the rearward-facing glare sensor provided in the rearview mirror assembly.

The control circuit may alternatively or additionally monitor the input from vibration sensing circuit 100, which may sense vibration when one or more people climb into the vehicle.

The noise amplifying circuit 150 and/or vibration sensing circuit 100 may also be utilized to provide information from which control circuit 50 may determine that the vehicle engine is running. If the control circuit 50 is receiving a signal from a glare light sensor 120 that is provided in an electrochromic rearview mirror used as the vehicle accessory 20, control circuit 50 may receive a feedback signal on line 86 corresponding to the amount of current drawn by electrochromic mirror 21. In general, the electrochromic mirror will dim when the glare sensor which faces to the rear of the vehicle senses a higher light level than is sensed by a forward-looking ambient light sensor. When this occurs, the electrochromic mirror will draw current and darken. Thus, by monitoring the current draw of the electrochromic mirror element, the control circuit 50 may determine that the light level behind the vehicle is higher and hence that a dome light or other lights within the vehicle have been turned on. The mirror assembly may also be configured to include a means for directly communicating certain information to power supply circuit 10, such as light levels or other information.

As described further below, control circuit 50 may also take into account what events are occurring within certain reasonable time periods so as to determine whether or not to start the supply of power from the vehicle battery 15 to vehicle accessory 20 or to disrupt the power. For example, if control circuit 50 properly detects that the vehicle is running but subsequently improperly continues to sense the engine is running for more than 24 hours, control circuit 50 may disrupt power upon expiration of this 24-hour period. Clearly, this 24-hour period could be a time period of some other duration. Also, the control circuit may monitor the battery voltage and if the voltage falls below some absolute threshold sensing the battery is nearly dead, the control circuit can then disrupt the power to the vehicle accessory.

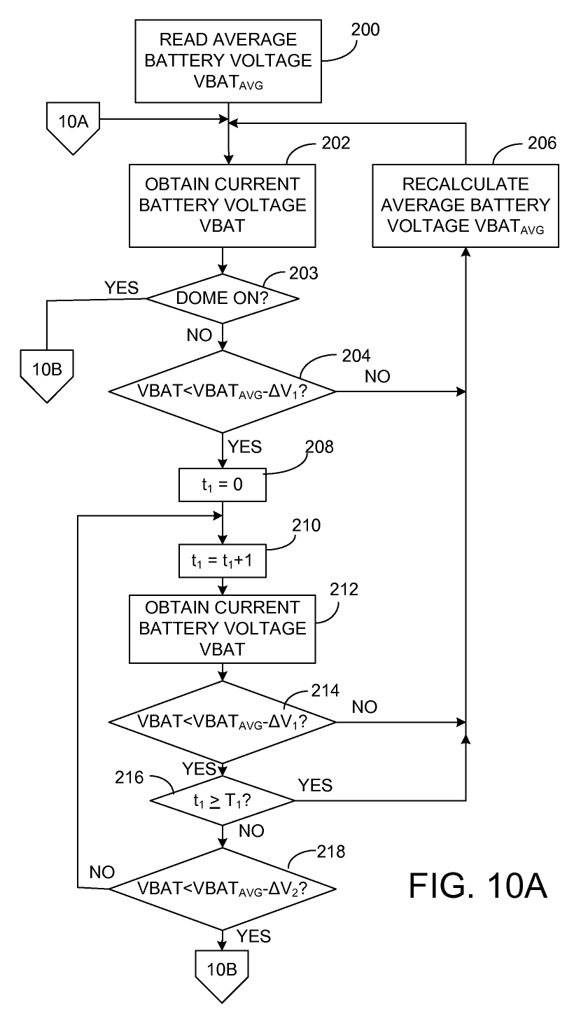

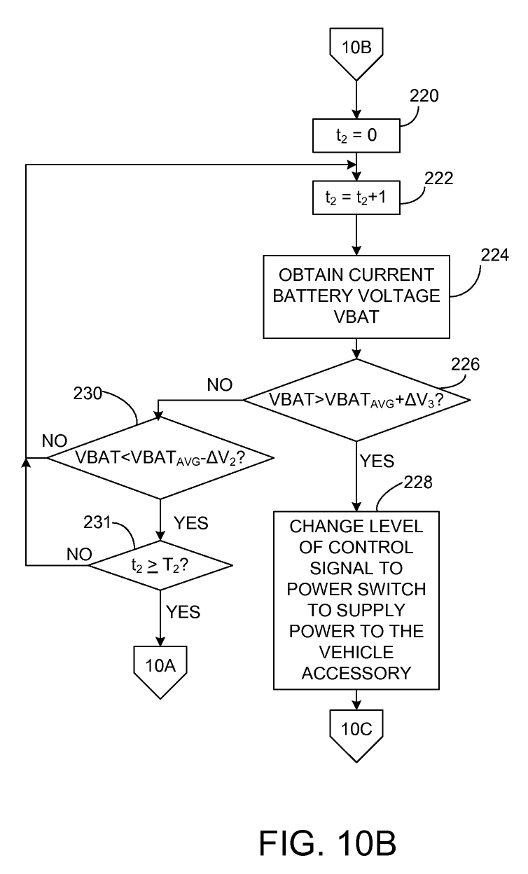

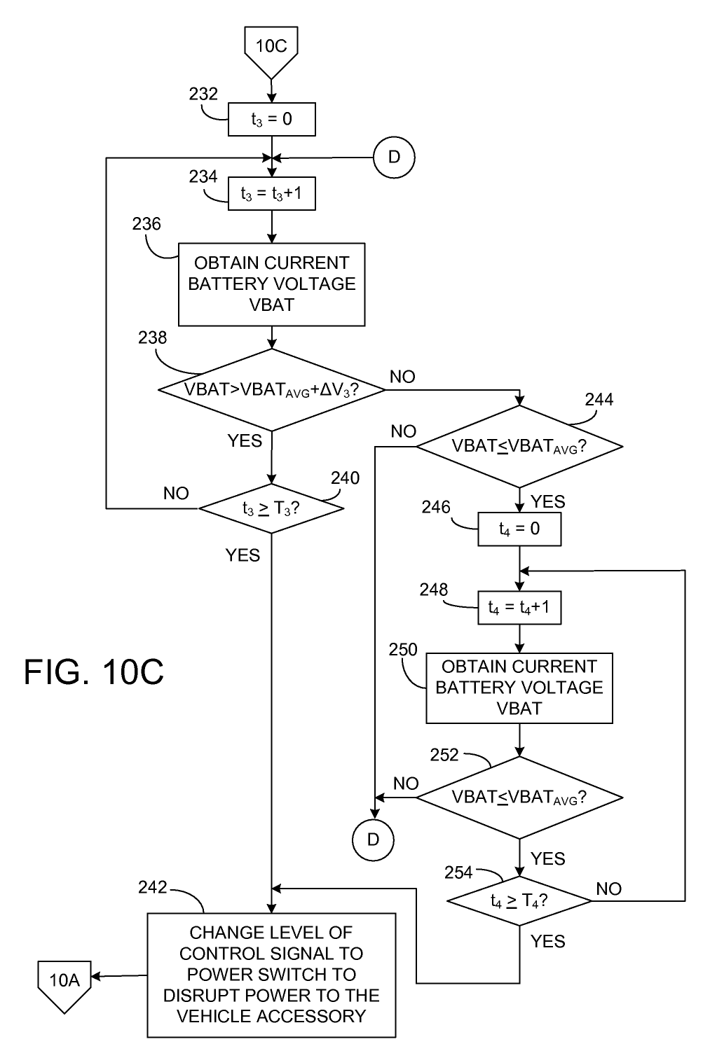

To help understand one embodiment that utilizes the battery voltage level as an input parameter, an exemplary flow chart is shown in FIGS. 10A-10C illustrating the processes performed by the microprocessor within control circuit 50.

The microprocessor may begin this exemplary process by reading the average battery voltage VBAT_{AVG} from memory. This memory may be the volatile or nonvolatile memory of the microprocessor. Then in step 202, the microprocessor obtains the current battery voltage VBAT.

In step 203, the microprocessor checks if the dome light is on. If the dome light is not on, the microprocessor advances to step 204, or otherwise it goes to step 220 in FIG. 10B. In step 204, the microprocessor determines whether the current battery voltage VBAT has dropped from the average battery average VBAT_{AVG} by an amount at least ΔV₁. Again, this voltage drop ΔV₁ corresponds to the voltage drop that would occur when a passenger has or is about to enter the vehicle. If there is no such voltage drop, the microprocessor then recalculates the average battery voltage VBAT_{AVG} in step 206 and then returns to step 202 to obtain the now current battery voltage VBAT. The microprocessor loops through steps 202, 204, and 206 until such time a voltage drop of at least ΔV₁ is detected in step 204.

Once the voltage drop of ΔV₁ has been detected, the microprocessor starts a timer t₁ by initiating the value t₁ to 0 in step 208 and subsequently incrementing this value by 1 in step 210. In step 212, the microprocessor again reads the current battery voltage VBAT. Then, in step 214, the microprocessor determines whether the current battery voltage read in step 212 is still at least ΔV₁ less than the average battery voltage VBAT_{AVG}. If the current voltage has remained at least ΔV₁ below VBAT_{AVG}, the microprocessor advances to step 216. Otherwise, the microprocessor returns to step 206. In step 216, the microprocessor then determines whether the counter ti has reached or exceeded a preset time period T₁. This first preset time period T₁ may be any time period during which one would reasonably expect that someone would subsequently begin cranking the engine after entering the vehicle. This time period may, for example, be anywhere from 5-10 minutes.

If timer t₁ has not reached or exceeded T₁, the microprocessor then checks whether or not VBAT obtained in step 212 has dropped more than ΔV₂ less than VBAT_{AVG}. If there has not been a further voltage drop, the microprocessor returns to step 210 to increment the timer counter t₁ and then obtain another battery voltage reading in step 212. The microprocessor then just continues to loop through steps 210-218 until such time that the battery voltage either rises again or the countdown timer t₁ exceeds the time limit T₁ in which case the microprocessor returns to step 206 to again loop through steps 202-206. However, if the current battery voltage VBAT subsequently represents a drop from the average battery voltage of at least ΔV₂, the microprocessor then proceeds to step 220 which is shown in FIG. 10B.

In step 220, the microprocessor starts a second timer t₂ by initiating t₂ at 0. Next, the microprocessor increments timer t₂ in step 222 and then obtains the current battery voltage VBAT in step 224. In step 226, it then determines whether the current battery voltage now exceeds the average battery voltage VBAT_{AVG} by at least ΔV₃. As shown in FIG. 9, this corresponds to the jump in voltage as a result of the engine beginning to run. Thus, if this jump in battery voltage occurs, then the microprocessor changes the level of the control signal applied to the power switch 30 to thereby supply power to vehicle accessory 20 as shown in step 228. The process then proceeds to step 232 in FIG. 10C. If, however, the battery voltage is not more than ΔV₂ less than the average voltage but is not more than ΔV₃ greater than the battery average, the microprocessor then checks whether VBAT is still at least ΔV₂ lower than VBAT_{AVG} in step 230. If so, the microprocessor then determines in step 231 whether or not timer t₂ has reached or exceeded a second time interval T₂. Second time interval T₂ is preferably 1 to 2 minutes. If timer t₂ has not exceeded T₂, the microprocessor returns to step 222 whereby countdown timer t₂ is incremented and the microprocessor obtains a new current battery voltage VBAT in step 224. The microprocessor thus loops through steps 222-231 until such time as either the countdown timer t₂ is equal to or exceeds T₂ or the current voltage level is no longer less than at least ΔV₂ less than the average battery voltage.

If the second countdown timer t₂ reaches or exceeds the second time interval T₂, then the microprocessor returns to step 202 in FIG. 10A.

In step 232 (FIG. 10C), the microprocessor begins running a third timer t₃. This third timer is used to determine whether a third time period T₃ is exceeded. Thus, in step 234, the microprocessor increments timer t₃ and then, in step 236, obtains the current battery voltage VBAT. In step 238, the microprocessor then determines whether the current battery voltage VBAT remains at least ΔV₃ above VBAT_{AVG}. So long as this condition is true, the microprocessor will then determine whether or not the third countdown timer t₃ has reached the end of the predetermined time period T₃ in step 240. If not, the microprocessor loops back to step 234 and continues to loop through steps 234-240 until such time that either VBAT falls indicating that the vehicle engine has been turned off, or timer t₃ exceeds the third time period T₃. The third time period T₃ represents the aforementioned very long time period of 24 hours whereby the control circuit causes switch 30 to disrupt the supply of power to vehicle accessory 20 despite the fact that VBAT had not fallen which would have indicated that the engine had been turned off. Thus, in this case the microprocessor proceeds to step 242 whereby it changes the level of the control signal to the power switch 30 to disrupt power to vehicle accessory 20. The procedure then returns to step 202 of FIG. 10A to await such a period whereby the battery voltage falls indicating that the engine is about to be turned back on.

If, in step 238, the microprocessor determines that VBAT is no longer at least ΔV₃ above VBAT_{AVG}, the microprocessor proceeds to step 244 where it determines if VBAT is less than or equal to VBAT_{AVG}. If VBAT has fallen back to VBAT_{AVG}, the microprocessor proceeds to step 246 whereby it starts a fourth timer t₄ by initiating t₄ to zero and then increments t₄ by one in step 248. The microprocessor then obtains a current VBAT in step 250 and determines if VBAT remains at or below VBAT_{AVG} in step 252. If VBAT remains at or below VBAT_{AVG}, the microprocessor proceeds to step 254 whereby it determines whether or not t₄ is equal to or greater than the constant T₄, which represents a fourth predetermined time period corresponding to a time during which it is expected that the battery voltage would remain at the lower level when the engine is turned off, rather than being a mere glitch in the battery voltage that may appear while the engine is still running. Thus, if timer t₄ has not yet reached the end of time period T₄, the microprocessor returns to step 248 and loops through the steps until such time that either the fourth time period expires or VBAT no longer remains at or below VBAT_{AVG}. If the timer expires in step 254, then the microprocessor advances to step 242 where it controls power switch 30 to disrupt the supply of power to vehicle accessory 20. Thus, by looking at the fourth time period T₄, the microprocessor insures that the drop in voltage is not a mere glitch detected while the vehicle is still running and also slightly delays turning off vehicle accessory 20 after the driver actually does turn off the vehicle ignition. In the event that VBAT no longer is at or below VBAT_{AVG} during processing of steps 244-252, the microprocessor returns to step 234 in assuming that the vehicle engine is still running. The microprocessor would then loop through the appropriate steps to determine to later turn off the vehicle accessory or continue until such time that the third predetermined time period T₃ expires, in which case the power would be disrupted to the vehicle accessory.

As an optional additional or alternative measure, the microcontroller may be programmed to disrupt the supply of power to the vehicle accessory if the battery voltage exceeds an upper absolute voltage limit. This upper absolute voltage limit could be selected to be above any voltage a new battery would exhibit in a perfect environment. This upper absolute voltage limit would thus be used to identify when the battery is being charged by a device other than the vehicle alternator. Likewise, as an optional additional or alternative measure, the microcontroller may be programmed to disrupt the supply of power to the vehicle accessory if the battery voltage falls below a lower absolute voltage limit. This lower absolute voltage limit could be selected to be lower than the lowest voltage the battery would otherwise exhibit during a typical ignition cycle as discussed above and would represent a voltage that suggests the battery unduly drained.

Although the above process has been described with respect to utilizing only the inputs of battery voltage and time, it will be appreciated that the microprocessor may be programmed to look at other inputs from light sensor 120, dome light status detection circuit 90, vibration sensing circuit 100, or noise amplifying circuit 150 as parameters to which the control circuit 50 may respond by controlling switch 30.

It will also be appreciated that the power supply circuit 10 may be used in a variety of vehicles of different make and model, or used in the same make and/or models but with different batteries that exhibit different characteristics. Accordingly, one of the benefits of utilizing a microprocessor in control circuit 50 is that the microprocessor may adaptively learn the characteristics of the vehicle and its battery as well as the characteristics of the vehicle accessories and other vehicle components within the environment in which the control circuit 50 is employed, and adjust the predetermined time periods and voltage change thresholds based upon the learned characteristics. For example, the voltage drop during cranking exhibited by one vehicle may not be as great as the voltage drop exhibited on the battery line of another vehicle due in part to a different engine, battery, alternator, or other loads of the battery. Thus, the microprocessor may initially utilize default values and then adjust those values once it is determined to what extent the battery voltage changes during engine cranking or start-up and the time periods during which these changes occur. The use of a microprocessor in the present invention therefore provides a significant advantage in that the power supply circuit 10 may be adaptive to the vehicle components with which it is used.

Another advantage of utilizing a microprocessor is that it may continually recalculate the average battery voltage and store this average in nonvolatile memory such that the nominal battery voltage may track that of the battery during changes in temperature while only looking at the amount the voltage changes during engine cranking or start-up relative to this moving average. The microprocessor may also calculate the rate of change of the battery voltage and use this as a parameter for controlling switch 30.

Still another advantage of providing a microprocessor in the power supply circuit is that the microprocessor may be programmed to receive inputs from several sources of information such as any one or more of circuits 60, 90, 100, and/or 150 and then selectively apply weighting factors to the various inputs while computing the probability that the driver has entered or is about to enter the vehicle, that the engine is being cranked, or that the engine is running or stopped. For example, if a voltage change does not quite reach the threshold change required, but otherwise all of the other indicators point to the engine either running or being stopped, the microprocessor may still determine that it is very likely that the engine is running and thus power up the vehicle accessory with the potential caveat that it the microprocessor may subsequently be more likely to disrupt power upon less than a full probability that the engine has been turned off.

As illustrated in FIG. 2, power supply circuit 10 is shown as being housed in its own housing 12 separate from that of dome light 80 or vehicle accessory 20. However, it will be appreciated that in some situations, it may be advantageous to integrate power supply circuit 10 either within the housing of the dome light 80 or the vehicle accessory 20. Thus, taking the rearview mirror assembly as an example, it may be possible that a vehicle has been manufactured with a standard rearview mirror assembly and with no ignition line run to the headliner and that the purchaser has elected to receive an advanced electrochromic mirror assembly to be installed by the auto dealer. However, if the vehicle only includes a battery line extending to the headliner for powering a dome light or other lights, it may be appropriate to keep power supply circuit 10 in its own housing 12 while using a standardized electrochromic mirror assembly. On the other hand, it is possible that the auto manufacturers may realize that the cost advantage of manufacturing vehicles directly with an electrochromic mirror assembly and no ignition line run to the headliner, thus making it desirable to incorporate the power supply circuit in the housing of the rearview mirror assembly. With the power supply circuit 10 incorporated within the rearview mirror assembly, a vehicle manufacturer could install the mirror assembly and simply connect the power line to the battery line in the headliner without having to run the ignition line into the headliner.

It should further be appreciated that some of the aspects of the invention may be employed to control the turning on or off of a vehicle accessory that is not powered by the battery of the vehicle, but rather powered by its own battery or one or more super capacitors. Such batteries may be primary batteries or rechargeable batteries that may be recharged using, for example, a solar panel or an adaptor for plugging into a cigarette lighter or other power outlet of the vehicle. Of the mechanisms discussed above for sensing whether to activate the vehicle accessory, perhaps only those that look for the particular characteristics of the vehicle battery would not be directly applicable when the vehicle accessory is powered by its own power source. For example, vibration sensing circuit 100, dome status detection circuit 90, or light sensor 120 may be used to determine whether to power up a vehicle accessory.

In the event the vehicle accessory is an electro-optic (i.e., electrochromic) rearview mirror, and in the event that the rearview mirror assembly includes its own power source in the form of a battery or capacitor, the rearview mirror assembly may be readily used to replace a conventional mirror as an aftermarket product. A solar cell may be placed in the mirror mount where the mirror attaches to the vehicle windshield so as to receive energy through the vehicle windshield in order to maintain the charge on the battery or capacitors. The rearview mirror assembly may employ the vibration sensing circuit 100, which may operate as a motion detector as well, and/or the light sensor 120 or dome light status detection circuit 90. In addition, the rearview mirror assembly may include the control circuit and power switch 30 so as to selectively power the electro-optic mirror element and any other vehicle accessories, such as a compass, a garage door transmitter, a light sensor, a microphone, a digital signal processor, a speaker, a headlamp controller, an imaging sensor, a blindspot indicator, a back-up warning indicator, a rear vision display, a light sensor, a wireless communication device, an audio and data transceiver, a cellular phone transceiver, a moisture sensor, an indicator, an illuminated switch, a GPS receiver, a microwave antenna, an RF antenna, a tire pressure sensing system receiver, a radar detector, and a remote keyless entry receiver. It may be beneficial to utilize an electro-optic mirror element that only requires power to cause it to switch states, but that does not require continuous power to remain in a particular state. This would further reduce the draw on the power source.

While the invention has been described in detail herein in accordance with certain preferred embodiments thereof, many modifications and changes therein may be affected by those skilled in the art without departing from the spirit of the invention. Accordingly, it is our intent to be limited only by the scope of the appending claims and not by way of the details and instrumentalities describing the embodiments shown herein.

What is claimed is:

1. A power supply circuit for selectively supplying power to an accessory in a vehicle, said power supply circuit comprising:
a switch coupled to a power line from a battery of the vehicle and to a power input of the accessory; and
a control circuit coupled to said switch, said control circuit comprising a microprocessor for monitoring a voltage level of the battery and for selectively activating said switch to supply power from the battery to the accessory in response to a sequence or combination of events.

2. The power supply circuit of claim 1, wherein said control circuit supplies power from the battery to the accessory when the voltage level of the battery increases a predetermined amount to a higher voltage level.

3. The power supply circuit of claim 1 and further comprising a battery voltage divider circuit coupled to the battery and said control circuit.

4. The power supply circuit of claim 1 and further comprising a vibration sensing circuit coupled to said control circuit, for sensing vibrations caused when the vehicle is running and for providing a vibration signal to said control circuit.

5. The power supply circuit of claim 1 and further comprising a noise amplifying circuit coupled to said control circuit and to the battery for sensing electrical noise caused when the vehicle is running and for providing an amplified noise signal to said control circuit.

6. The power supply circuit of claim 1, wherein said control circuit is configured to receive a dome light signal indicative of whether a dome light has been turned on.

7. The power supply circuit of claim 6, wherein said control circuit is configured to receive the dome light signal from a light sensor that detects a light level output from the dome light.

8. The power supply circuit of claim 6, wherein said control circuit is configured to receive the dome light signal from a dome light status detection circuit that is electrically coupled to the dome light.

9. The power supply circuit of claim 1, wherein said control circuit is configured to receive an operating signal from the vehicle accessory.

10. The power supply circuit of claim 1, wherein said control circuit supplies power from the battery to the accessory when the voltage level of the battery decreases from a nominal voltage level by a first predetermined amount to a lower voltage level and subsequently increases a second predetermined amount to a higher voltage within a predetermined time period.

11. The power supply circuit of claim 1, wherein said control circuit supplies power from the battery to the accessory when the voltage level of the battery decreases from a nominal voltage level by a first predetermined amount to a lower voltage level.

12. The power supply circuit of claim 1, wherein said microprocessor controls said switch when changes in the battery voltage level exceed predetermined voltage change thresholds, wherein said microprocessor adjusts the voltage change thresholds after learning characteristics of the battery voltage over time.

13. The power supply circuit of claim 1, wherein said microprocessor monitors the battery voltage over time and determines the probability that the vehicle is running based upon the manner and extent by which the battery voltage changes.

14. The power supply circuit of claim 13, wherein said microprocessor receives at least two of the following inputs: a voltage level of the battery; a vibration sensor output signal; a light level within the vehicle; noise on the power line from the battery; a door open signal; a timer signal; a signal read from the vehicle accessory; and a dome light on signal, and assigns probability weightings to these inputs based upon the likelihood that their values indicate that the vehicle engine is running or is not running.

15. The power supply circuit of claim 1, wherein said microprocessor receives at least two of the following inputs: a voltage level of the battery; a vibration sensor output signal; a light level within the vehicle; noise on the power line from the battery; a door open signal; a timer signal; a signal read from the vehicle accessory; and a dome light on signal.

16. A power supply circuit for selectively supplying power to an accessory in a vehicle, said power supply circuit comprising:
a switch coupled to a power line from a battery of the vehicle and to a power input of the accessory; and
a control circuit coupled to said switch, said control circuit monitors a voltage level of the battery and selectively supplies power from the battery to the accessory in response to the voltage level of the battery, wherein said control circuit supplies power from the battery to the accessory when the voltage level of the battery increases at least a predetermined amount.

17. The power supply circuit of claim 16, wherein said predetermined amount is at least about 1 volt.

18. The power supply circuit of claim 16, wherein said control circuit computes an average of the battery voltage level and selectively supplies power from the battery to the accessory when the averaged voltage level of the battery increases a predetermined amount.

19. The power supply circuit of claim 16, wherein said control circuit controls said switch when changes in the battery voltage level exceed predetermined voltage change thresholds, wherein said control circuit adjusts the voltage change thresholds after learning characteristics of the battery voltage over time.

20. The power supply circuit of claim 16, wherein said control circuit monitors the battery voltage over time and determines the probability that the vehicle is running based upon the manner and extent by which the battery voltage changes.

21. The power supply circuit of claim 16 and further comprising a battery voltage divider circuit coupled to the battery and said control circuit.

22. A power supply circuit for selectively supplying power to an accessory in a vehicle, said power supply circuit comprising:
a switch coupled to a power line from a battery of the vehicle and to a power input of the accessory; and
a control circuit coupled to said switch, said control circuit monitors a voltage level of the battery and selectively supplies power from the battery to the accessory in response to the voltage level of the battery, wherein said control circuit supplies power from the battery to the accessory when the voltage level of the battery decreases from a nominal voltage level by a first predetermined amount to a lower voltage level and subsequently increases a second predetermined amount to a higher voltage within a predetermined time period.

23. The power supply circuit of claim 22, wherein said second predetermined amount is at least about 1 volt.

24. The power supply circuit of claim 22, wherein said predetermined time period is less than about 2 seconds.

25. The power supply circuit of claim 22, wherein said control circuit computes an average of the battery voltage level and selectively supplies power from the battery to the accessory when the averaged voltage level of the battery increases a predetermined amount.

26. A power supply circuit for selectively supplying power to an accessory in a vehicle, said power supply circuit comprising:
a switch coupled to a power line from a battery of the vehicle and to a power input of the accessory; and
a control circuit coupled to said switch, said control circuit monitors a voltage level of the battery, computes an average of the battery voltage level, and selectively supplies power from the battery to the accessory in response to the averaged voltage level of the battery.

27. The power supply circuit of claim 26, wherein said control circuit computes the averaged battery voltage level by averaging voltage levels read during a predetermined time interval.

28. The power supply circuit of claim 26, wherein said control circuit comprises a microprocessor.

29. A power supply circuit for selectively supplying power to an accessory in a vehicle, said power supply circuit comprising:
a switch coupled to a power line from a battery of the vehicle and to a power input of the accessory; and
a control circuit coupled to said switch, said control circuit monitors a voltage level of the battery and selectively supplies power from the battery to the accessory in response to the voltage level of the battery, wherein said control circuit disrupts a supply of power from the battery to the accessory when the voltage level of the battery decreases from a first voltage level by at least a predetermined amount to a lower voltage level.

30. A power supply circuit for selectively supplying power to an accessory in a vehicle, said power supply circuit comprising:
a switch coupled to a power line from a battery and to a power input of the accessory; and
a control circuit coupled to said switch, said control circuit monitors a voltage level of the battery and selectively supplies and disrupts power from the battery to the accessory in response to at least two of the following inputs in addition to a time duration of detected events: a voltage level of the battery; a vibration sensor output signal; a light level within the vehicle; noise on the power line from the battery; a door open signal; a timer signal; a signal read from the vehicle accessory; and a dome light on signal.

31. The power supply circuit of claim 30, wherein said control circuit monitors the battery voltage over time and determines the probability that the vehicle is running based upon the manner and extent by which the battery voltage changes.

32. The power supply circuit of claim 30, wherein said control circuit assigns probability weightings to the inputs based upon the likelihood that their values indicate that the vehicle engine is running or is not running.

33. The power supply circuit of claim 30, wherein said control circuit controls said switch when changes in the battery voltage level exceed predetermined voltage change thresholds, wherein said microprocessor adjusts the voltage change thresholds after learning characteristics of the battery voltage over time.

34. The power supply circuit of claim 30, wherein the battery is a battery of the vehicle that is remote from the accessory.

35. The power supply circuit of claim 30, wherein the battery is disposed within the accessory.

36. An accessory for mounting in a vehicle comprising:
a power source;
an electrical component;
a switch coupled between said electrical component and said power source; and
a control circuit coupled to said switch and selectively supplies and disrupts power from said power source to said electrical component in response to at least one of the following inputs: a motion sensor output signal; a vibration sensor output signal; a light level within the vehicle; and a dome light ON signal.

37. The accessory of claim 36, wherein the electrical component comprises at least one of: an electro-optic mirror element; a display; a light; a compass; a garage door opener transmitter; a light sensor; a microphone; a digital signal processor; a speaker; a headlamp controller; an imaging sensor; a blindspot indicator; a back-up warning indicator; a rear vision display; a light sensor; a wireless communication device; an audio and data transceiver; a cellular phone transceiver; a moisture sensor; an indicator; an illuminated switch; a GPS receiver; a microwave antenna; an RF antenna; a tire pressure sensing system receiver; a radar detector; and a remote keyless entry receiver.

38. The accessory of claim 36, wherein the accessory is a rearview mirror assembly.
